(19) United States
(12) Patent Application Publication
(10) Pub. No.: US 2026/0022999 A1
(43) Pub. Date: Jan. 22, 2026

(54) STEADY LOAD TESTING APPARATUS AND METHODS

(71) Applicant: The Boeing Company, Arlington, VA (US)

(72) Inventors: Jagdish L. Shinde, Bengaluru (IN); Suman Murugesan, Bengaluru (IN); Yathish Belakavadi Madashetty, Bengaluru (IN); Thegaraja Annamalai, Bengaluru (IN)

(21) Appl. No.: 18/775,905

(22) Filed: Jul. 17, 2024

(51) Int. Cl. G01N 3/14

(52) U.S. Cl. CPC G01N 3/14; G01N 2203/0003; G01N 2203/0016; G01N 2203/0033; G01N 2203/0641

(57) ABSTRACT

Steady load testing apparatus and methods are disclosed. An example test machine comprises a support extending vertically from a base, a weight assembly including a rod extending along a vertical axis, the rod to couple to a test article, a block coupled to the support, the block to guide the rod such that the rod moves along the vertical axis, an actuator operatively coupled to the block, the actuator to selectively fix and release the rod, a mounting bracket operatively coupled to the support, the mounting bracket to couple to the test article such that the test article aligns with the vertical axis, and a sensor to measure movement of the weight assembly along the vertical axis.

### FIELD

This disclosure relates generally to test equipment and, more particularly, to steady load testing apparatus and methods.

### BACKGROUND

Conventional testing machines, such as tensile testing machines, operate on a principle of applying displacement to a test article via a lead screw, pneumatic cylinder, or other linear motion device. The test articles are secured by fixtures to a base of the testing machine and to a movable portion, such as a cross head, of the testing machine. Conventional testing machines are controlled primarily for achieving a specified displacement or maintaining a specified velocity while applying compression and/or tension to the test article. Displacement is typically measured based on the movement of the cross head relative to the base. Conventional testing machines record changing loads as the test article is displaced or otherwise strained.

### SUMMARY

An example test machine includes a support extending vertically from a base, a weight assembly including a rod, the rod extending along a vertical axis, the rod to couple to a test article, a block coupled to the support, the block to guide the rod such that the rod moves along the vertical axis, an actuator operatively coupled to the block, the actuator to selectively fix and release the rod, a mounting bracket operatively coupled to the support, the mounting bracket to couple to the test article such that the test article aligns with the vertical axis, and a sensor to measure movement of the weight assembly along the vertical axis.

An example method for testing rate controllers includes adding a load to a test machine, the load removably coupled to a load assembly, the load assembly coupled to the test machine such that the load assembly moves vertically relative to the test machine, operatively coupling a rate controller to the test machine, the rate controller rotatably coupled to a fixture at a first end of the rate controller and rotatably coupled to the load assembly at a second end of the rate controller such that the load assembly is above the fixture, moving the load assembly to a starting position, fixing the load assembly via an actuator coupled to the test machine, the actuator to selectively prevent vertical movement of load assembly relative to the test machine, beginning position measurement with a displacement sensor coupled to the test machine, the displacement sensor to measure a position of the load assembly relative to the starting position, releasing the load assembly via the actuator, and recording the position of the load assembly over time until the load assembly reaches a stopping position.

An example apparatus includes a mass operatively coupled to a support, the mass to move in a direction coincident with a gravitational force, a fixture coupled to the mass to selectively prevent movement of the mass relative to the support, a position measurement device coupled to the support, the position measurement device to measure a distance between the mass and the position measurement device, and a mount coupled to the support, the mount to hold a compressible test specimen, the compressible test specimen to be selectively coupled to the mount and the mass.

### BRIEF DESCRIPTION OF THE DRAWINGS

FIG. 1 is an example steady load testing machine.

FIG. 2 illustrates an example weight assembly coupled to the example testing machine of FIG. 1 via an example bushing block.

FIG. 3A is a top view of the example bushing block of FIG. 2.

FIG. 3B is a cross-section of the example bushing block of FIG. 2 with an example actuator.

FIG. 4A illustrates an example load cell block, an example mounting bracket, and an example guide block used with the testing machine of FIG. 1.

FIG. 4B illustrates an example test article coupled to the example mounting bracket and the example guide block of FIG. 4A.

FIG. 5 illustrates an example hoist and an example linear actuator that can be used to move the example weight assembly of FIG. 1.

FIG. 6 is a flowchart representative of an example method for performing a steady load test for an example rate controller.

In general, the same reference numbers will be used throughout the drawing(s) and accompanying written description to refer to the same or like parts. The figures are not necessarily to scale.

### DESCRIPTION

Example methods and apparatus disclosed herein are for a steady load testing machine for use with rate controller components such as dampers, dashpots, snubbers, and other fixed stroke actuators. Known testing machines, such as tensile testing machines, operate on a principle of applying displacement to a test article or maintaining a specified velocity while applying compression and/or tension to a test article. However, known testing machines cannot apply a constant load to the test article and measure the resulting displacement. Some conventional testing machines approximate constant loading via a feedback loop where applied strain rates are constantly altered to maintain the target loading. Such feedback loops require complex and expensive equipment and do not represent true constant loading nor the behaviors of the test article when in use.

The example apparatus disclosed herein allows steady load testing by applying a prescribed load to the test article and accurately measuring displacement as the test article reacts to the load. This is achieved by physical weights that are placed on the test article and allowed to move along a controlled axis defined by a supporting test stand. The test is completed when the test article fully displaces, or the physical weights come to rest on a stopper. The displacement of the test article is measured either at predetermined intervals or throughout the test, allowing the motion of the test article to be tracked over time while the constant load is applied. In this way, the quality and performance of the test article can be verified without damaging the test article.

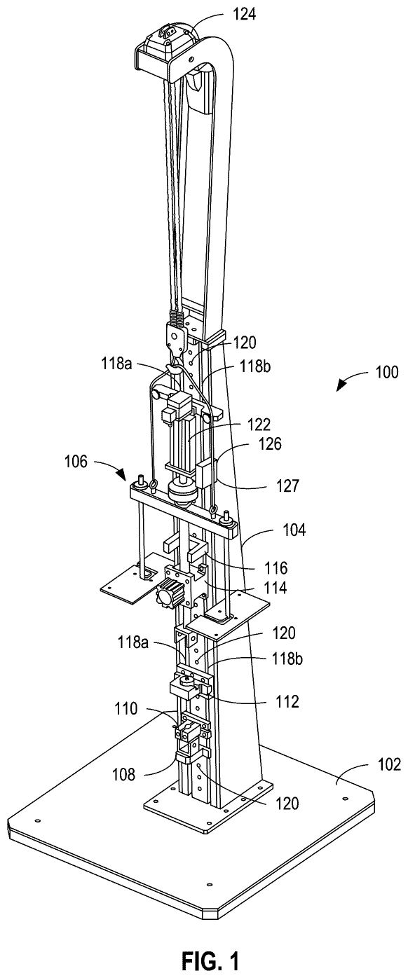

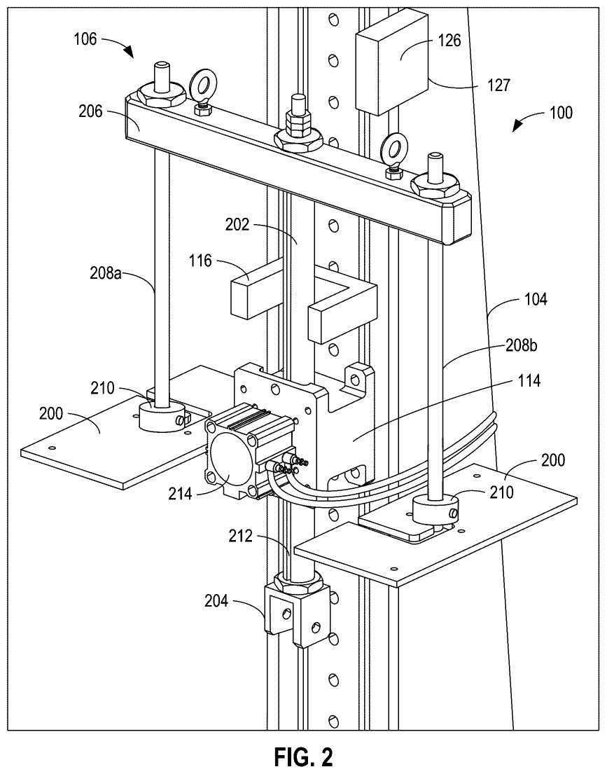

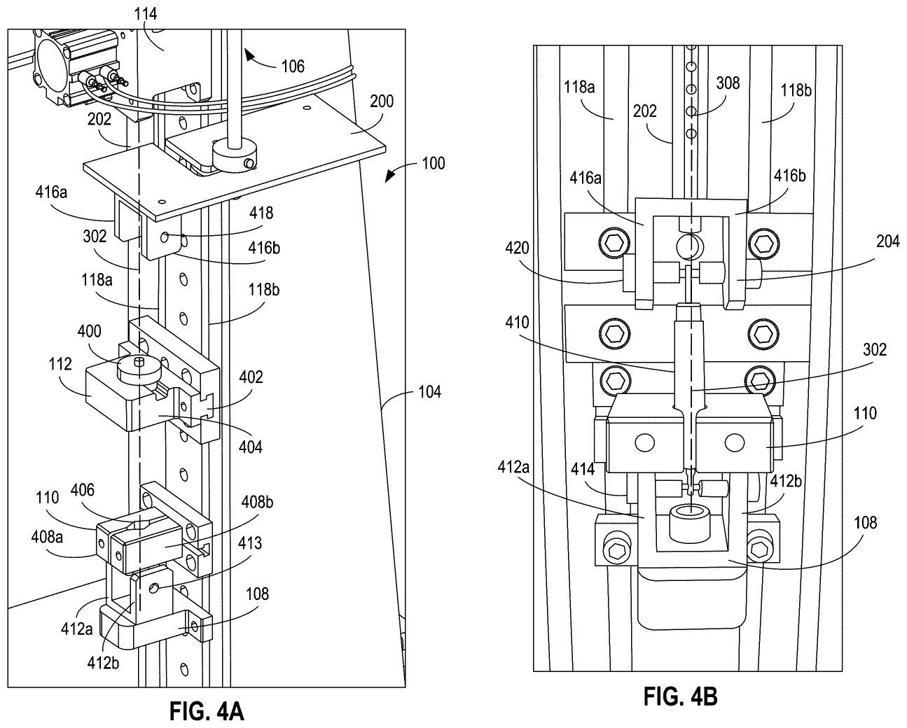

FIG. 1 is an example steady load testing machine 100. The testing machine 100 (e.g., test machine) includes an example base 102 and an example stand 104 (e.g., frame, support, etc.). The base 102 supports the stand 104 and provides stability to the testing machine 100. The stand 104 extends vertically from the center of the base 102. The testing machine 100 includes a weight assembly 106 that provides a constant load during a test (described in more detail below in reference to FIG. 2). The stand 104 supports example fixtures including an example mounting bracket 108, an example guide block 110, and an example load cell block 112 (described in more detail below in reference to FIGS. 4A and 4B). Additionally, the stand 104 supports example fixtures including an example bushing block 114 and an example stopper 116 (described in more detail below in reference to FIG. 2).

The stand 104 of FIG. 1 includes example mounting slots 118a, 118b to couple the fixtures the stand 104. The mounting slots 118a, 118b extend vertically along the length of the stand 104. The mounting slots 118a, 118b are parallel to allow fixtures to be shifted and positioned precisely in a vertical direction relative to one another. For example, the mounting slots 118a, 118b include sliding fasteners (e.g., t-slot nuts, t-slot bolts) that can be tightened to lock the fixtures in place or loosened to allow fixtures to slide vertically. In some examples, the fixtures are coupled to example mounting points 120 along a vertical length of the stand 104. For clarity, not all of the mounting points 120 are labeled. In some examples, the mounting points 120 are tapped holes positioned at regular intervals (e.g., at a same distance between neighboring mounting points 120). The mounting slots 118a, 118b and/or the mounting points 120 allow the fixtures to be positioned on the stand 104 at different vertical positions. In this way, the testing machine 100 can accommodate test articles (e.g., test specimens) of different sizes and lengths.

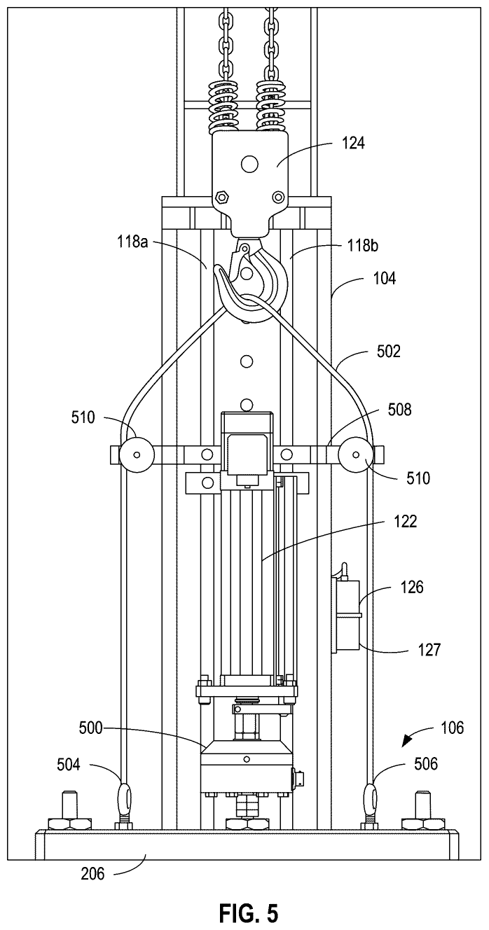

The weight assembly 106 of FIG. 1 is positioned by an example linear actuator 122 and/or an example hoist 124. The linear actuator 122 is coupled to the stand 104 (e.g., to the mounting slots 118a, 118b) to hold the weight assembly 106 when preparing for a test. The linear actuator 122 is selectively coupled (e.g., coupled and uncoupled) to the weight assembly 106 to position the weight assembly 106 prior to a test (as further detailed below in reference to FIG. 5). In some examples, particularly when testing with large loads (e.g., over 50 kilograms), the hoist 124 is coupled to the top of the stand 104. The hoist 124 is selectively coupled (e.g., coupled and uncoupled) to the weight assembly 106 to position the weight assembly 106 prior to a test (as further detailed below in reference to FIG. 5).

An example displacement sensor 126 is coupled to the stand 104 of FIG. 1. The displacement sensor 126 is coupled to the stand 104 above the weight assembly 106 and oriented to measure a position of the weight assembly 106 (e.g., a position of a component of the weight assembly 106). In this way, the displacement sensor 126 measures the position of the weight assembly 106 during a test to determine a displacement of a test article coupled to the weight assembly 106. The example displacement sensor 126 of FIG. 1 is a laser displacement sensor including an example controller 127 to receive and record data from the displacement sensor 126. In other examples, the displacement sensor 126 can be a different kind of sensor (e.g., a linear variable differential transformer (LVDT), a glass scale, a linear encoder, etc.).

FIG. 2 illustrates the example weight assembly 106 coupled to the example testing machine 100 of FIG. 1 via the example bushing block 114. The weight assembly 106 (e.g., a load assembly) carries example weights 200 (e.g., loads, masses, etc.) to transfer a load of the weights 200 to a test article. The weight assembly 106 includes an example center rod 202 that couples to an example bracket 204 at a bottom end of the center rod 202. The bracket 204 couples to the test article (described in more detail below in reference to FIG. 4B), transferring the load of the weight assembly 106 to the test article. The center rod 202 is cylindrical and has a length greater than its diameter. In some examples, the weight assembly 106 includes an example cross bar 206 coupled to a top end of the center rod 202, opposite the bracket 204. The cross bar 206 is oriented perpendicular to the center rod 202. The cross bar 206 couples and uncouples from different components of the testing machine 100 (e.g., the linear actuator 122, the hoist 124, the weight assembly 106, etc.). In some examples, the cross bar 206 has a square cross-section with flat surfaces to accept mounting hardware. In some examples, the cross bar 206 includes tapped holes to receive threaded fasteners such as screws and eyebolts. In other examples, the cross bar 206 includes through holes to receive threaded fasteners fixed with nuts. The cross bar 206 is coupled to the center rod 202 at or near the middle of the elongate length of the cross bar 206. In this way, a weight of the cross bar 206 is evenly distributed relative to the center rod 202 in order to reduce or eliminate any moment between the cross bar 206 and the center rod 202.

The weights 200 of FIG. 2 are removably coupled to the cross bar 206 to increase the load transferred to the test article. In some examples, the weights 200 rest on example supports 208 near the ends of the cross bar 206 (e.g., a first support 208a at or near a first end of the cross bar 206 and a second support 208b at or near a second end of the cross bar 206 opposite the first end). In some examples, the supports 208 are cylindrical rods with a flanged bottom end and a threaded top end. The threaded top end of each support 208 receives a nut to couple the support 208 to the cross bar 206. The flanged bottom end of each support 208 provides a flat surface to receive the weights 200. In other examples, the supports 208 can have a different shape to couple to the cross bar 206 and receive the weights 200. In some examples, the supports 208 can hold a plurality of weights 200 (e.g., multiple weights 200 stacked and centered on the support 208). In this way, a total mass of the weight assembly 106 can be changed to meet a load requirement of a test specific to the test article. In some examples, example tie-downs 210 (e.g., fixtures) are disposed on the supports 208 to secure the weights 200 in place.

The tie-downs 210 are selectively fixed (e.g., fastened with set screws) to the supports 208, such that the tie-downs 210 slide up and down the supports 208. In this way, the tie-downs 210 can secure (e.g., fix) one or more weights 200 to prevent the weights 200 from moving during a test. The weights 200 are distributed along the cross bar 206 such that the additional load of the weights 200 does not cause a moment on the cross bar 206 (e.g., an equal mass of weights 200 are placed on both sides of the cross bar 206 at an equal distance from the center rod 202). The weights 200 are illustrated with an example size and shape (e.g., thin rectangular plates), but in other examples the weights 200 can have different shapes (e.g., discs, spheres, etc.) and/or sizes. The example weights 200 are suspended from the example cross bar 206 on the example supports 208. In other examples, the weights 200 can be placed on different locations of the cross bar 206 (e.g., on top of the cross bar 206, positioned concentrically to the center rod 202, etc.).

The stopper 116 of FIG. 2 prevents downward motion of the weight assembly 106 past the stopper 116. In some examples, the stopper 116 is coupled to the stand 104 (e.g., fastened via the mounting slots 118a, 118b) at a position between the bushing block 114 and the cross bar 206 of the weight assembly 106. The stopper 116 extends away from stand 104 to a distance equal to or greater than a distance from the stand 104 to the weight assembly 106. In some examples, the stopper 116 includes a pair of forks with square cross-sections extending away from the stand 104. In other examples, the stopper 116 includes a pair of forks with a different cross-section (e.g., a circular cross-section). The stopper 116 stops motion of the weight assembly 106 when the cross bar 206 comes into contact with the stopper 116. In other words, the stopper 116 supports the entire load of the weight assembly 106 when the weight assembly 106 comes to rest on the stopper 116. In this way, the stopper 116 can be used to stop vertical motion of the weight assembly 106 as well as control how far the test article will be compressed during the test.

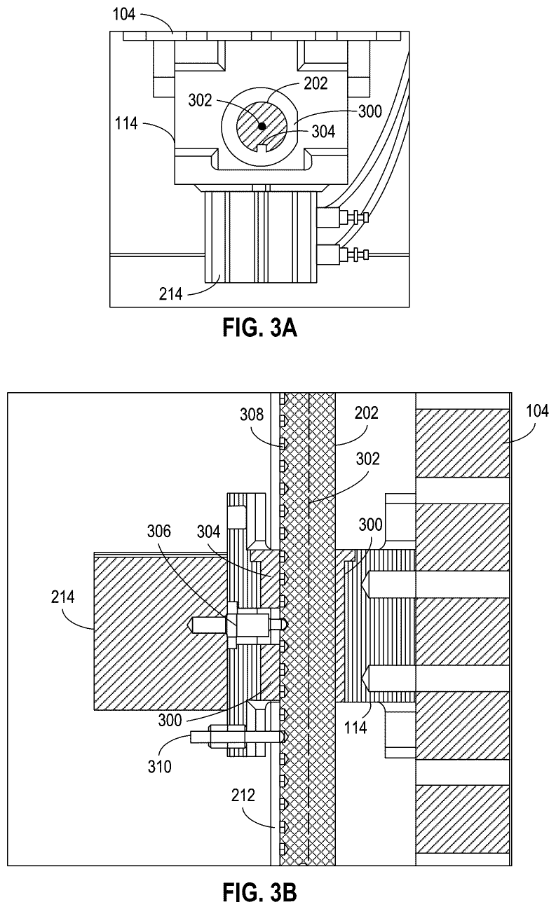

The bushing block 114 of FIG. 2 receives the center rod 202 and guides the motion of the weight assembly 106. The bushing block 114 is mounted to the stand 104 (e.g., fastened via the mounting slots 118a, 118b) and receives the center rod 202 such that the center rod 202 can move freely in the vertical direction. The bushing block 114 aligns the center rod 202 with a test article such that the center rod 202 can move along a vertical axis defined by the guide block 110 (further detailed below in relation to FIGS. 4A and 4B). In this way, the load of the weight assembly 106 is transferred directly to a test article along the vertical axis to limit any moments that may be introduced due to misalignment of the center rod 202 relative to the test article. In some examples, the center rod 202 includes an example alignment slot 212 running along the length of the center rod 202 in a vertical direction. An example actuator 214 is coupled to the bushing block 114 to selectively couple with the center rod 202 (as described in further detail below in reference to FIGS. 3A and 3B). In this way, the actuator 214 can hold and release the weight assembly 106 to initiate a test of a test article. In some examples, the actuator 214 is coupled to a face of the bushing block 114 opposite the stand 104 (e.g., a front face). In other examples, the actuator 214 is coupled to a different face (e.g., a side face) of the bushing block 114. In some examples, the actuator 214 is integrated with the bushing block 114 and shares a common structure.

FIG. 3A is a top view of the example bushing block 114 of FIG. 2. The bushing block 114 includes an example bushing 300 that receives the center rod 202. The bushing 300 guides the center rod 202 along an example vertical axis 302. In other words, the bushing 300 slidably couples the center rod 202 to the bushing block 114. The vertical axis 302 is positioned on the testing machine 100 relative to the base 102 (not shown) such that the vertical axis 302 coincides with a direction of gravitational force (e.g., the testing machine 100 is level and the vertical axis 302 is plumb). In some examples, the bushing 300 is a cylindrical sleeve with a flange along a stop edge. The bushing 300 is sized to match the center rod 202 so that the center rod 202 cannot move in a direction perpendicular to the vertical axis 302. In this way, the mass of the weight assembly 106 (not shown) and the resulting load (e.g., the weight of the weight assembly 106) is directly transferred to a test article without angle losses. In some examples, the bushing 300 includes an example tab 304 to mate with the alignment slot 212. The tab 304 includes a profile (e.g., a rectangular key) on an inner surface of the bushing 300 extending in a direction parallel with the vertical axis 302. In this way, the center rod 202 does not rotate about the vertical axis 302 (e.g., the center rod 202 is rotationally fixed) while the tab 304 is engaged with the alignment slot 212. In some examples, the bushing 300 includes a low friction material to reduce friction forces as the center rod 202 moves. In other examples, the bushing 300 includes ball bearings or other friction reducing elements (e.g., lubrication) to reduce friction forces as the center rod 202 moves.

FIG. 3B is a cross-section of the example bushing block 114 of FIG. 2 with the example actuator 214. The actuator 214 moves an example load pin 306 (e.g., locking pin) to selectively couple with the center rod 202. In some examples, the actuator 214 is a pneumatic actuator using pressurized air to move the load pin 306. In other examples, the actuator 214 uses other actuation methods to move the load pin 306 (e.g., a solenoid, a rack and pinion gear set, a lead screw, etc.) powered by other sources (e.g., electricity, hydraulic pressure, etc.). The load pin 306 is cylindrical in shape. In other examples, the load pin 306 can have a different shape (e.g., a square cross-section). The bushing 300 has an opening (e.g., a hole) to allow the load pin 306 to pass through the bushing 300. The center rod 202 includes a plurality of example holes 308 disposed in the alignment slot 212, perpendicular to the vertical axis 302. For clarity, not all holes 308 have been labeled in FIG. 3B. In other examples, the holes 308 are positioned on a different location of the center rod 202 (e.g., rotated 90 degrees around the vertical axis 302 relative the alignment slot 212). The holes 308 are sized to receive the load pin 306. Thus, the actuator 214 selectively couples the center rod 202 to the bushing block 114 by inserting and removing the load pin 306 into one of the holes 308. In other words, the actuator 214 locks the weight assembly 106 (not shown) in place based on a signal (e.g., a control command, an application of power, etc.) received from a user. By including the plurality of holes 308 in the center rod 202, weight assembly 106 can be fixed at a plurality of different starting positions, corresponding to the plurality of holes 308, without requiring the bushing block 114 to be moved to a new position along the stand

The bushing block 114 includes an example guide pin 310 that selectively couples with one of the holes 308. In some examples, the guide pin 310 is manually inserted into the bushing block 114 (e.g., through a guide hole in the bushing block 114) and/or one of the holes 308. The guide pin 310 has a cylindrical shape sized to match the holes 308. In some examples, the guide pin 310 includes a handle to facilitate holding and inserting the guide pin 310 through the bushing block 114. The guide pin 310 is shown proximate a lower edge of the bushing block 114 (e.g., below the actuator 214). In other examples, the guide pin 310 can be positioned proximate an upper edge of the bushing block 114 (e.g., above the actuator 214). In this example, the holes 308 are evenly spaced such that each hole 308 is a same distance apart from the next closest (e.g., an adjacent) hole 308 (e.g., 6 mm center to center). In other examples, different (e.g., unequal) spacings may be used to suit the needs of a particular application. The guide pin 310 and the load pin 306 are positioned in the bushing block 114 at a fixed distance such that the guide pin 310 and the load pin 306 can couple to respective ones of the holes 308. In this way, the guide pin 310 can position the center rod 202 along the vertical axis 302 prior to the actuator 214 being activated. In other words, the center rod 202 can be manually positioned using the guide pin 310 to ensure that the load pin 306 successfully couples to a hole 308 to fix the center rod 202 in place. Once the center rod 202 is fixed in place by the load pin 306, the guide pin 310 can be removed.

FIG. 4A illustrates the example load cell block 112, the example mounting bracket 108, and the example guide block 110 to be used with the testing machine 100 of FIG. 1. In some examples, the load cell block 112 is coupled to the stand 104 (e.g., via the mounting slots 118a, 118b) below the bushing block 114. The load cell block 112 positions an example load cell 400 along the vertical axis 302. The load cell 400 is used to measure a load generated by the weight assembly 106 (e.g., a combined weight of the weight assembly 106 and the weights 200) before the weight assembly 106 is coupled to a test article. The weight assembly 106 is lowered by the hoist 124 and/or the linear actuator 122 (not shown) onto the load cell 400 until the load cell 400 supports the full load of the weight assembly 106. In this way, a load applied to a test article can be determined (e.g., verified) before beginning a test. Once the load applied via the weight assembly 106 is verified, the load cell block 112 is decoupled from the stand 104 and the weight assembly 106 is positioned by the linear actuator 122 and/or hoist 124 (not shown) to prepare for the test. In some examples, the load cell block 112 includes an example slot 402 and an example tray 404 to hold the load cell 400. The tray 404 is removably coupled to the load cell block 112 via the slot 402. In this way, the load cell block 112 can remain coupled to the stand 104 (e.g., via the mounting slots 118a, 118b) while the tray 404 is removed to perform a test.

The mounting bracket 108 is coupled to the stand 104 (e.g., via the mounting slots 118a, 118b) below the load cell block 112 and the guide block 110. The mounting bracket 108 receives a test article and supports a load transferred through the test article from the weight assembly 106. Above the mounting bracket 108, a guide block 110 is coupled to the stand 104 (e.g., via the mounting slots 118a, 118b). The guide block 110 includes an example groove 406 to receive a body of a test article and align the test article along the vertical axis 302. In other words, the guide block 110 prevents the test article from moving out of alignment with the vertical axis 302. In this way, the test article is positioned to receive loads along the vertical axis 302 without experiencing moments that could damage the test article or alter the effective compressive force experienced by the test article. In some examples, the guide block 110 includes a relatively soft material (e.g., nylon, polyurethane, etc.) to contact the test article so that the guide block 110 does not damage the test article. In some examples, the groove 406 is a cylindrical hole sized to receive a test article. In other examples, the guide block 110 includes two example jaws 408a, 408b and the groove 406 is a pair of chamfered grooves. In this way, the jaws 408a, 408b can be moved to accommodate test articles with cylindrical bodies of different diameters.

FIG. 4B illustrates an example test article 410 coupled to the example mounting bracket 108 and example guide block 110 of FIG. 4A. The test article 410 is a compressible rate controller (e.g., a damper, a snubber, an actuator, etc.) that will react to the load of the weight assembly 106 (not shown). In some examples, the test article 410 is compressed by the weight assembly 106 (e.g., the weight assembly 106 travels towards the mounting bracket 108). In other examples, the test article 410 is compressed prior to the test and the weight assembly 106 is lifted as the test article 410 expands. The mounting bracket 108 includes two example parallel vertical portions 412a, 412b (e.g., forks) with example holes 413 (as shown in FIG. 4A) that align to receive an example mounting pin 414. The mounting pin 414 is sized to couple to the test article 410 and transfer loads from the test article 410 to the mounting bracket 108. By directing the mounting pin 414 through a first vertical portion 412a of the mounting bracket 108, through the test article 410, and through the second vertical portion 412b of the mounting bracket 108, the test article 410 is free to rotate around the mounting pin 414 in the same way as the test article 410 would be used in application. In other words, the test article 410 is rotatably coupled to the mounting bracket 108 with the mounting pin 414 so that no torque is transferred between the mounting bracket 108 and the test article 410.

In FIG. 4B, the bracket 204 of the weight assembly 106 couples to the test article 410 opposite the mounting bracket 108. The bracket 204 is coupled to the center rod 202 and transfers the load of the weight assembly 106 to the test article 410 along the vertical axis 302. The bracket 204 includes two example parallel vertical portions 416a, 416b (e.g., forks) with example holes 418 (as shown in FIG. 4A) that align to receive an example pin 420. The pin 420 is sized to couple to the test article 410 and transfer loads from the weight assembly 106 to the test article 410. By directing the pin 420 through a first vertical portion 416a of the bracket 204, through the test article 410, and through the second vertical portion 416b of the bracket 204, the test article 410 is free to rotate around the pin 420 in the same way as the test article 410 would be used in application. In other words, the test article 410 is rotatably coupled to the bracket 204 with the pin 420 so that no torque is transferred between the bracket 204 and the test article 410. The mounting bracket 108, the mounting pin 414, the guide block 110, the bracket 204, and the pin 420 are sized to receive or engage with the test article 410. However, in the event of testing differently sized test articles 410, the mounting bracket 108, the mounting pin 414, the guide block 110, the bracket 204, and/or the pin 420 can be replaced with similar but differently sized mounting brackets, mounting pins, guide blocks, brackets, and pins.

FIG. 5 illustrates the example hoist 124 and the example linear actuator 122 that can be used to move the example weight assembly 106 of FIG. 1. For illustration purposes, the hoist 124 and the linear actuator 122 are shown connected to the cross bar 206 of the weight assembly 106. However, in practice, one of the hoist 124 or the linear actuator 122 can be used independently, with the other uncoupled from the cross bar 206. The linear actuator 122 is coupled to the stand 104 (e.g., via the mounting slots 118a, 118b) above the weight assembly 106. The linear actuator 122 is selectively coupled to the weight assembly 106 to move the weight assembly 106 vertically (e.g., along the vertical axis 302). In some examples, the linear actuator 122 is coupled to the weight assembly 106 via a threaded rod and a lock nut. In other examples, the linear actuator 122 is coupled to the weight assembly 106 via a hook of the linear actuator 122 engaging an eyebolt of the weight assembly 106. The linear actuator 122 allows the weight assembly 106 to be quickly moved to install or remove a test article. The linear actuator 122 can position the weight assembly 106 to set a starting displacement for the test article. In some examples, the linear actuator 122 compresses the test article a predetermined amount. In some examples, the linear actuator 122 includes a lead screw driven by an electric motor. In other examples, the linear actuator 122 can include a different actuation method (e.g., rack and pinion, pneumatic motor, hydraulic cylinder, etc.). Once the weight assembly 106 is correctly positioned, the weight assembly 106 is locked into position by the actuator 214 (not shown). The linear actuator 122 is then decoupled from the weight assembly 106 to allow for the test to be performed. In some examples, the linear actuator 122 includes an example load cell 500. The load cell 500 can be used to measure a load (e.g., a weight) of the weight assembly 106 while the linear actuator 122 moves the weight assembly 106.

The hoist 124 is selectively coupled to the weight assembly 106 to move the weight assembly 106 vertically. In some examples, the hoist 124 is coupled to the testing machine 100 at a top edge of the testing machine 100, opposite the base 102. In some examples, the hoist 124 is coupled to the weight assembly 106 via an example cable 502. The cable 502 is coupled to the cross bar 206 of the weight assembly 106 such that a first end 504 and a second end 506 of the cable 502 are coupled to the cross bar 206, the first end 504 and second end 506 equally or approximately equally spaced from the center rod 202 (not shown) such that little or no moment is introduced by lifting the cross bar 206. In some examples, an example cable guide 508 (e.g., an aligner) is coupled to the stand 104 (e.g., via the mounting slots 118a, 118b) between the hoist 124 and the weight assembly 106. The cable guide 508 includes two example rollers 510 symmetrically placed relative to the vertical axis 302. The rollers 510 are positioned to guide the cable 502 such that the first end 504 and the second end 506 of the cable 502 are perpendicular to the cross bar 206 when supporting the weight assembly 106. Similarly to the linear actuator 122, the hoist 124 allows for positioning of the weight assembly 106 relative to the other fixtures on the testing machine 100. In some examples, the hoist 124 is an electric hoist actuated with an electric motor. In other examples, the hoist 124 is a manual hoist actuated manually (e.g., a chain hoist, a lever hoist).

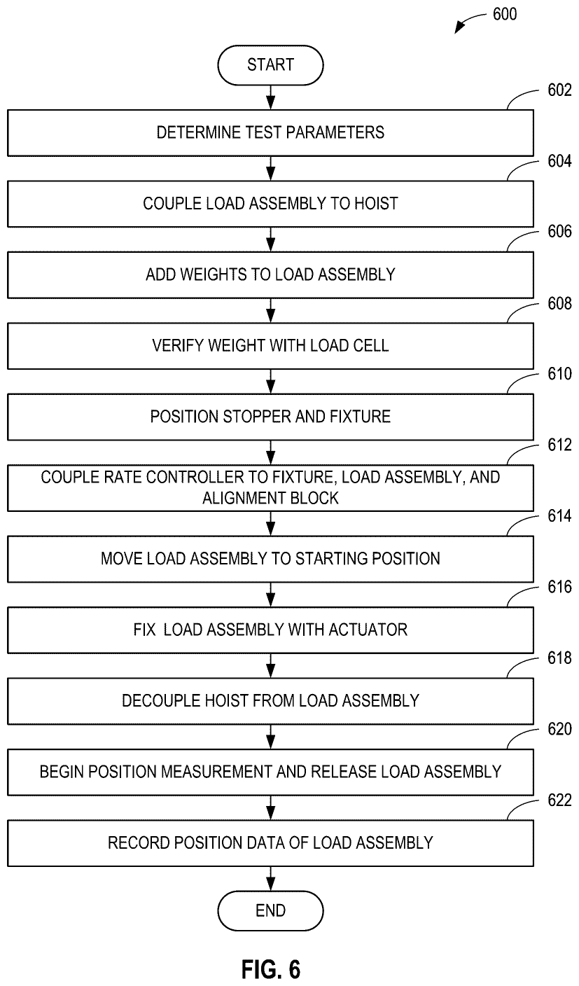

FIG. 6 is a flowchart representative of an example method 600 for performing a steady load test for an example rate controller. The method begins at block 602, where test parameters are determined for the rate controller (e.g., test article 410) test. The rate controller is designed to control the motion of an object, such as a door to a storage compartment. As such, the rate controller has a test stroke length (e.g., a total displacement of the rate controller during use, a maximum total displacement, etc.), a test load (e.g., an amount of force the rate controller resists during use, a maximum load, etc.), and a movement rate. To test the rate controller, a load equal to the test load is applied over the test stroke length and the movement of the rate controller (e.g., the compression rate, the expansion rate, etc.) is measured. The test parameters include the test load and the test stroke length that correspond to the specific type (e.g., style) of rate controller being tested. The stroke length is defined by a starting point (e.g., a maximum displacement, a maximum elongated length) and an ending point (e.g., a minimum displacement, a minimum compressed length, a stopping point). Different rate controller types have different test stroke lengths and different test loads that are applied. Once the rate controller is identified, the corresponding test parameters can be assigned based on testing standards and procedures.

Once the test parameters are determined, the method 600 of FIG. 6 continues to block 604 where a load assembly (e.g., weight assembly 106) is coupled to a hoist (e.g., hoist 124, linear actuator 122) of a steady load testing machine (e.g., testing machine 100). The hoist carries the load of the load assembly and allows the load assembly to be moved vertically. The method 600 continues to block 606, where weights (e.g., a load) are added to the load assembly. The weights (e.g., metal plates) add mass to the load assembly to increase the load. Weights are added to or removed from the load assembly to match the test load that was determined in block 602. The method 600 of FIG. 6 continues to block 608, where the weight of the load assembly is verified with a load cell. The load assembly is lowered onto the load cell until the full weight of the load assembly is resting on the load cell. The load cell measures the weight of the load assembly so that the weight can be compared to the test load.

The method 600 of FIG. 6 continues to block 610, where a stopper (e.g., stopper 116) and a fixture (e.g., mounting bracket 108) are positioned on the steady load testing machine. The fixture receives the rate controller and fixes one end of the rate controller to the steady load testing machine. The stopper is positioned above the fixture and prevents the load assembly from moving below the stopper. In this way, an ending point of the stroke length can be defined by the relative positions of the fixture and the stopper. In other words, the minimum compressed length of the rate controller is the difference between the distance from the fixture to the stopper and distance that the load assembly extends beyond the stopper (e.g., the length of the center rod 202 and the bracket 204).

The method 600 of FIG. 6 continues to block 612, where the rate controller is coupled to the fixture, the load assembly, and an alignment block (e.g., the guide block 110). The rate controller couples (e.g., rotatably couples) to the fixture on a first end of the rate controller. The rate controller couples (e.g., rotatably couples) to the load assembly on a second end of the rate controller. The first and second ends of the rate controller are the working ends that move relative to each other. In this way, the test load of the load assembly will be received by the second end of the rate controller and transferred through the rate controller into the first end of the rate controller.

The alignment block is coupled to the rate controller to orient the rate controller in line with the motion of the load assembly. In this way, the alignment block ensures that the rate controller does not move (e.g., rotate, translate) if the load from the load assembly and the reaction forces from the fixture are not aligned. The fixture and alignment block are coupled to (e.g., fastened to) the steady load testing machine so that the fixture and alignment block can support the test loads transferred through the rate controller from the load assembly.

The method 600 of FIG. 6 continues to block 614, where the load assembly is moved to a starting position. The hoist raises or lowers the load assembly, which results in the second end of the rate controller moving relative to the first end of the rate controller. In this way, a starting point of the stroke length can be defined by the relative position of the first end of the rate controller and the second end of the rate controller. In other words, the maximum elongated length of the rate controller is set by the position of the load assembly. The method 600 continues to block 616, where the load assembly is fixed in place with an actuator (e.g., the actuator 214). The actuator is coupled to the steady load testing machine and selectively supports the load of the load assembly. The actuator receives a signal from a user to fix (e.g., to lock in place, to prevent vertical movement of, etc.) the load assembly. In some examples, the load assembly is aligned with the actuator using a guide pin (e.g., guide pin 310) inserted through the actuator and into the load assembly prior to sending the signal to fix the load assembly. The method 600 continues to block 618, where the hoist is decoupled from the load assembly. After the load assembly is fixed by the actuator, the hoist can be moved such that the full load of the load assembly is supported by the actuator. Once the hoist is no longer supporting the load assembly, the hoist can be decoupled or otherwise removed from the load assembly.

The method of 600 of FIG. 6 continues to block 620, where position measurement is begun, and the load assembly is released. A displacement sensor (e.g., displacement sensor 126) of the steady load testing machine monitors a position of the load assembly relative to the starting position. To start the steady load test, the displacement sensor is prepared for use (e.g., powered on, calibrated, zeroed, etc.). Once the displacement sensor is prepared, the user sends a signal to the actuator to release the load assembly. Once released, the load assembly is guided by the actuator (e.g., aligned to the rate controller) but the load of the load assembly is fully supported by the rate controller. Gravity begins to pull the load assembly down and the rate controller moves away from the starting position. The method concludes with block 622, where the position data of the load assembly is recorded. As the load assembly falls, position data is recorded by a controller (e.g., controller 127) of the displacement sensor. In this way, data correlating time with distance travelled is generated. The load assembly continues to move until the stroke length is completed. In other words, the load assembly is released and continues to move until it stops (e.g., rests upon the stopper, reaches a stopping position, travels a threshold distance, etc.), signaling the end of the test. In some examples, the recording is stopped manually via a user input. In other examples, the recording is stopped automatically via a sensor or control logic from the sensor controller. Thus, the performance of the rate controller is measured to determine how the rate controller will perform in an end use application or to maintain a quality control of the rate controller.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

From the foregoing, it will be appreciated that example systems, apparatus, articles of manufacture, and methods have been disclosed that enable steady load testing of rate controlling devices such as dampers, dashpots, snubbers, and other mechanical actuators. Testing apparatus disclosed herein allow a constant load generated by physical weights to be applied to a rate controller without the need for complex and expensive feedback equipment. The testing apparatus disclosed herein can be quickly adapted for rate controllers of varying sizes and functions by changing weights and fixturing hardware. In this way, disclosed testing apparatus can be used for performance and quality control testing over a wide variety of rate controllers. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to enable steady load testing of rate controlling devices are disclosed herein. Further examples and combinations thereof include the following:

Example 1 includes a test machine comprising a support extending vertically from a base, a weight assembly including a rod, the rod extending along a vertical axis, the rod to couple to a test article, a block coupled to the support, the block to guide the rod such that the rod moves along the vertical axis, an actuator operatively coupled to the block, the actuator to selectively fix and release the rod, a mounting bracket operatively coupled to the support, the mounting bracket to couple to the test article such that the test article aligns with the vertical axis, and a sensor to measure movement of the weight assembly along the vertical axis.

Example 2 includes the test machine of example 1, wherein the weight assembly includes a support to receive one or more weights.

Example 3 includes the test machine of example 2, wherein the weight assembly includes a fixture to selectively fix the one or more weights to the support.

Example 4 includes the test machine of any one of examples 1-3, wherein the rod includes a plurality of holes, each one of the plurality of holes to receive a locking pin, the locking pin to be selectively inserted into one of the plurality of holes via the actuator.

Example 5 includes the test machine of any one of examples 1-4, wherein the rod includes a slot and the block includes a bushing to receive the rod, the bushing having a tab, the slot to receive the tab such that the rod is rotationally fixed about the vertical axis.

Example 6 includes the test machine of any one of examples 1-5, further including a stopper coupled to the support below the weight assembly.

Example 7 includes the test machine of any one of examples 1-6, further including a linear actuator selectively coupled to the weight assembly to move the weight assembly along the vertical axis.

Example 8 includes the test machine of any one of examples 1-8, further including a load cell removably coupled to the support.

Example 9 includes the test machine of any one of examples 1-8, wherein the sensor is a laser displacement sensor.

Example 10 includes the test machine of any one of examples 1-9, further including a hoist coupled to a top end of the support, the hoist to selectively raise and lower the weight assembly, the hoist selectively coupled to the weight assembly via a cable, a first end of the cable coupled to the weight assembly at a first point and a second end of the cable coupled to the weight assembly at a second point, the first point positioned apart from the second point.

Example 11 includes the test machine of any one of examples 1-10, further including a guide block coupled to the support above the mounting bracket.

Example 12 includes a method for testing rate controllers, the method comprising adding a load to a test machine, the load removably coupled to a load assembly, the load assembly coupled to the test machine such that the load assembly moves vertically relative to the test machine, operatively coupling a rate controller to the test machine, the rate controller rotatably coupled to a fixture at a first end of the rate controller and rotatably coupled to the load assembly at a second end of the rate controller such that the load assembly is above the fixture, moving the load assembly to a starting position, fixing the load assembly via an actuator coupled to the test machine, the actuator to selectively prevent vertical movement of load assembly relative to the test machine, beginning position measurement with a displacement sensor coupled to the test machine, the displacement sensor to measure a position of the load assembly relative to the starting position, releasing the load assembly via the actuator, and recording the position of the load assembly over time until the load assembly reaches a stopping position.

Example 13 includes the method of example 12, further including measuring a weight of the load assembly with a load cell, the load cell coupled to the test machine below the load assembly.

Example 14 includes the method of any one of examples 12 or 13, wherein coupling the rate controller to the test machine includes coupling an alignment block to the test machine, the alignment block to orient the rate controller such that a movement of the rate controller aligns with the vertical movement of the load assembly.

Example 15 includes the method of any one of examples 12-14, wherein the load assembly includes a plurality of holes spaced along a vertical axis and the actuator includes a pin to selectively engage a first one of the plurality of holes.

Example 16 includes the method of example 15, further including positioning the load assembly relative to the actuator by inserting a guide pin into one of the plurality of holes, the guide pin to engage the actuator through a guide hole in the actuator, the guide hole spaced apart from the pin of the actuator such that the pin aligns with the first one of the plurality of holes after the guide pin engages a second one of the plurality of holes.

Example 17 includes an apparatus comprising a mass operatively coupled to a support, the mass to move in a direction coincident with a gravitational force, a fixture coupled to the mass to selectively prevent movement of the mass relative to the support, a position measurement device coupled to the support, the position measurement device to measure a distance between the mass and the position measurement device, and a mount coupled to the support, the mount to hold a compressible test specimen, the compressible test specimen to be selectively coupled to the mount and the mass.

Example 18 includes the apparatus of example 17, further including a positioning device to raise and lower the mass relative to the mount, the positioning device to be selectively coupled to the mass.

Example 19 includes the apparatus of any one of examples 17 or 18, further including a stop coupled to the support, the stop to prevent a motion of the mass once the mass travels a threshold distance towards the mount.

Example 20 includes the apparatus of any one of examples 17-19, further including a controller to receive distance measurements from the position measurement device and record the distance measurements over a period of time.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A test machine comprising:
a support extending vertically from a base;
a weight assembly including a rod, the rod extending along a vertical axis, the rod to couple to a test article;
a block coupled to the support, the block to guide the rod such that the rod moves along the vertical axis;
an actuator operatively coupled to the block, the actuator to selectively fix and release the rod;
a mounting bracket operatively coupled to the support, the mounting bracket to couple to the test article such that the test article aligns with the vertical axis; and
a sensor to measure movement of the weight assembly along the vertical axis.

2. The test machine of claim 1, wherein the weight assembly includes a support to receive one or more weights.

3. The test machine of claim 2, wherein the weight assembly includes a fixture to selectively fix the one or more weights to the support.

4. The test machine of claim 1, wherein the rod includes a plurality of holes, each one of the plurality of holes to receive a locking pin, the locking pin to be selectively inserted into one of the plurality of holes via the actuator.

5. The test machine of claim 1, wherein the rod includes a slot and the block includes a bushing to receive the rod, the bushing having a tab, the slot to receive the tab such that the rod is rotationally fixed about the vertical axis.

6. The test machine of claim 1, further including a stopper coupled to the support below the weight assembly.

7. The test machine of claim 1, further including a linear actuator selectively coupled to the weight assembly to move the weight assembly along the vertical axis.

8. The test machine of claim 1, further including a load cell removably coupled to the support.

9. The test machine of claim 1, wherein the sensor is a laser displacement sensor.

10. The test machine of claim 1, further including:
a hoist coupled to a top end of the support, the hoist to selectively raise and lower the weight assembly, the hoist selectively coupled to the weight assembly via a cable, a first end of the cable coupled to the weight assembly at a first point and a second end of the cable coupled to the weight assembly at a second point, the first point positioned apart from the second point.

11. The test machine of claim 1, further including a guide block coupled to the support above the mounting bracket.

12. A method for testing rate controllers, the method comprising:
adding a load to a test machine, the load removably coupled to a load assembly, the load assembly coupled to the test machine such that the load assembly moves vertically relative to the test machine;
operatively coupling a rate controller to the test machine, the rate controller rotatably coupled to a fixture at a first end of the rate controller and rotatably coupled to the load assembly at a second end of the rate controller such that the load assembly is above the fixture;
moving the load assembly to a starting position;
fixing the load assembly via an actuator coupled to the test machine, the actuator to selectively prevent vertical movement of load assembly relative to the test machine;
beginning position measurement with a displacement sensor coupled to the test machine, the displacement sensor to measure a position of the load assembly relative to the starting position;
releasing the load assembly via the actuator; and
recording the position of the load assembly over time until the load assembly reaches a stopping position.

13. The method of claim 12, further including measuring a weight of the load assembly with a load cell, the load cell coupled to the test machine below the load assembly.

14. The method of claim 12, wherein coupling the rate controller to the test machine includes coupling an alignment block to the test machine, the alignment block to orient the rate controller such that a movement of the rate controller aligns with the vertical movement of the load assembly.

15. The method of claim 12, wherein the load assembly includes a plurality of holes spaced along a vertical axis and the actuator includes a pin to selectively engage a first one of the plurality of holes.

16. The method of claim 15, further including positioning the load assembly relative to the actuator by inserting a guide pin into one of the plurality of holes, the guide pin to engage the actuator through a guide hole in the actuator, the guide hole spaced apart from the pin of the actuator such that the pin aligns with the first one of the plurality of holes after the guide pin engages a second one of the plurality of holes.

17. An apparatus comprising:
a mass operatively coupled to a support, the mass to move in a direction coincident with a gravitational force;
a fixture coupled to the mass to selectively prevent movement of the mass relative to the support;
a position measurement device coupled to the support, the position measurement device to measure a distance between the mass and the position measurement device; and
a mount coupled to the support, the mount to hold a compressible test specimen, the compressible test specimen to be selectively coupled to the mount and the mass.

18. The apparatus of claim 17, further including a positioning device to raise and lower the mass relative to the mount, the positioning device to be selectively coupled to the mass.

19. The apparatus of claim 17, further including a stop coupled to the support, the stop to prevent a motion of the mass once the mass travels a threshold distance towards the mount.

20. The apparatus of claim 17, further including a controller to receive distance measurements from the position measurement device and record the distance measurements over a period of time.
